(19) United States
(12) Patent Application Publication
(10) Pub. No.: US 2011/0045356 A1
(43) Pub. Date: Feb. 24, 2011

(54) BATTERY

(76) Inventors: Isao Fujiwara, Osaka (JP); Mikinari Shimada, Osaka (JP); Seiichi Kato, Osaka (JP)

Correspondence Address: MCDERMOTT WILL & EMERY LLP, 600 13TH STREET, NW, WASHINGTON, DC, 20005-3096, US

(21) Appl. No.: 12/809,750

(22) PCT Filed: May 20, 2009
(86) PCT No.: PCT/JP2009/002229

§ 371 Date: Jun. 21, 2010

(30) Foreign Application Priority Data
May 22, 2008 (JP) 2008-133848

(51) Int. Cl. H01M 2/16

(52) U.S. Cl. 429/247

(57) ABSTRACT

In a battery in which each of a positive electrode plate 4 and a negative electrode plate 8 is formed by coating a surface of a strip-shaped current collector 5, 9 with an active material layer 6, 10 and in which an electrode group 13 formed by winding or stacking the positive electrode plate 4 and the negative electrode plate 8 with a separator 2 interposed therebetween and an electrolyte are housed in a battery case 14, at least a predetermined portion of the separator 2 associated with either a coating start/terminal end 6a, 10a of the active material layer 6, 10 or an end of the current collector 5, 9 is formed as a modified physical-property portion 2a having a strength against a crush.

### TECHNICAL FIELD

The present disclosure relates to batteries, typified by secondary batteries and lithium batteries, housing separators and improved to have high safety.

### BACKGROUND ART

Lithium ion secondary batteries, which have been widely used as power sources of mobile electronic equipment in recent years, use carbonaceous materials or other materials allowing insertion and extraction of lithium as active materials for negative electrode plates, and also use complex oxides of transition metals and lithium, such as LiCoO₂, as active materials for positive electrode plates, thereby achieving high potential and high discharge capacity. However, with a recent increase in the number of functions of electronic equipment and communication equipment, the capacity of lithium ion secondary batteries needs to be further increased. With the increase in the capacity of such lithium ion secondary batteries, serious consideration needs to be given to safety measures. In particular, it is very important to prevent an internal short circuit between a positive electrode plate and a negative electrode plate.

However, a separator might be pierced with: a start/terminal end of an active material layer of a positive or negative electrode plate when a material mixture paste to be the active material layer is applied to a current collector; a cutting end of a coating film and a cutting end of a positive or negative electrode current collector when the positive or negative electrode plate coated with the coating film is cut into a strip having a desired width; and an angulated end and a cutting burr of a positive or negative electrode lead. In this case, a short circuit might occur.

In general, as a conventional method for preventing this problem, as illustrated in FIG. 9, a technique of providing a current collector 25 with an exposed portion where an active material layer 26 of an electrode plate 28 is not formed, connecting a lead 27 to the current collector 25, and then coating the lead 27 and the electrode plate 28 with an insulating film 23 is proposed (see, for example, PATENT DOCUMENTS 1 and 2).

In addition, as illustrated in FIG. 10, a technique of providing an electrode plate with an exposed portion where a current collector 25 is exposed, attaching an insulating film 23 to a portion extending from a portion near an end of an active material layer 26 to the exposed portion, and thereby reducing the thickness of an end of the insulating film 23, is also proposed (see, for example, PATENT DOCUMENT 3).

### CITATION LIST

### Patent Document

PATENT DOCUMENT 1: Japanese Patent Publication No. H06-103971

PATENT DOCUMENT 2: Japanese Patent Publication No. H07-320770

PATENT DOCUMENT 3: Japanese Patent Publication No. 2005-235414

### SUMMARY OF THE INVENTION

### Technical Problem

However, in the conventional technique shown in PATENT DOCUMENT 1 or 2, a thick insulating film is attached to an active material layer so that the active material layer 26 located under the insulating film 23 is integrated with the insulating film 23 and is fixed, thereby reducing extension and contraction of the electrode plate 28 during winding and charge/discharge. Consequently, in an end of the insulating film 23, a crack is created between a portion of the active material layer 26 fixed to the insulating film 23 and a portion of the active material layer 26 not fixed to the active material layer 26. As a result, lithium might be deposited on the current collector 25. In addition, the broken active material layer 26 might penetrate through a separator (not shown) during expansion and contraction or winding to cause an internal short circuit.

Further, since part of the active material layer 26 is firmly fixed by the insulating film 23, the active material layer 26 fixed by the insulating film 23 at the inner surface of the current collector 25 cannot be deformed according to a curvature during winding of the electrode group. As a result, tensile stress is concentrated in the current collector 25 made of aluminium foil or copper foil to cause breakage of the current collector 25.

Further, it is difficult to prevent a short circuit by attaching the insulating film 23 to the entire surface of a cutting end of the active material layer 26 formed when the electrode plate 28 is cut into a strip having a desired width.

More specifically, in PATENT DOCUMENTS 1 and 2, the insulating film 23 attached to an end of the active material layer 26 causes a crack in the active material layer 26, resulting in that the current collector 25 is easily broken during winding.

On the other hand, in PATENT DOCUMENT 3, to reduce breakage of the current collector 25, the thickness of an end of the insulating film 23 and the thickness of a portion of the insulating film 23 on an end of the active material layer 26 are reduced. In this case, occurrence of breakage can be reduced, but the foregoing problems are not fundamentally solved. Consequently, the current collector 25 is likely to be broken.

It is therefore an object of the present invention to provide a battery having an increased crushing strength of a separator and exhibiting reduced occurrence of an internal short circuit and high safety by forming modified physical-property portions having high strength against a crush in portions of a separator associated with angulated portions of, for example, positive and negative electrode plates and a current collector.

### Solution to the Problem

To achieve the object, in a battery in one aspect of the present invention, each of a positive electrode plate and a negative electrode plate is formed by coating a surface of a strip-shaped current collector with an active material layer, and an electrode group formed by winding or stacking the positive electrode plate and the negative electrode plate with a separator interposed therebetween and an electrolyte are housed in a battery case. In the battery, at least a predetermined portion of the separator associated with either a coating start/terminal end of the active material layer or an end of the current collector is formed as a modified physical-property portion having a strength against a crush.

This configuration can reduce occurrence of defects, such as an internal short circuit, which are likely to occur in specific portions.

In another aspect of the present invention, the modified physical-property portion of the separator is preferably formed by performing hot pressing or discharging on the predetermined portion of the separator. This configuration can reduces occurrence of defects in specific portions where an internal short circuit is likely to occur.

In another aspect of the present invention, the modified physical-property portion of the separator is preferably formed by filling the predetermined portion of the separator with a resin material, bonding the resin material to the predetermined portion of the separator, or combining the resin material with the predetermined portion of the separator. In this case, the crushing strength of the modified physical-property portion of the separator can be further increased.

In another aspect of the present invention, the modified physical-property portion of the separator is preferably located inside the separator. In this case, pores in the surface of the separator can be filled, thereby reducing extension of cracks starting from pores in the surface.

In another aspect of the present invention, the modified physical-property portion of the separator is preferably located in a surface of the separator. In this case, the active material layer can be deformed according to a curvature during winding of the electrode group. As a result, concentration of tensile stress in the current collector can be reduced, thereby reducing breakage of the current collector.

In another aspect of the present invention, preferably, the strip-shaped current collector is formed by cutting a sheet-shaped current collector having a surface on which the active material layer is formed, and a portion of the separator associated with a cutting end of the active material layer is also formed as the modified physical-property portion of the separator. In this case, the battery can have a structure in which ion movement during charge and discharge of the battery is not affected in portions except for the modified physical-property portion.

In another aspect of the present invention, preferably, a current collector lead is connected to a portion of the current collector where the active material layer is not formed, and a portion of the separator associated with an end of the current collector lead is also formed as the modified physical-property portion of the separator. This configuration can reduce occurrence of defects, such as an internal short circuit, which easily occur in specific portions.

### ADVANTAGES OF THE INVENTION

In a battery using a separator according to the present invention, at least a portion of the separator associated with either a coating start/terminal end of an active material layer or an end of a current collector is formed as a modified physical-property portion having a strength against a crush, thereby reducing an internal short circuit. As a result, a battery having high safety can be obtained.

### BRIEF DESCRIPTION OF THE DRAWINGS

FIG. 1 is a view schematically illustrating an electrode group formed by winding a separator for a nonaqueous secondary battery according to an embodiment of the present invention.

FIG. 2 is a view schematically illustrating a modified physical-property portion of the separator for the nonaqueous secondary battery of the embodiment.

FIGS. 3(a) and 3(b) are cross-sectional views illustrating a separator for the nonaqueous secondary battery of the embodiment in which modified physical-property portions are formed in both surfaces of the separator.

FIG. 4 is a cross-sectional view illustrating a separator for the nonaqueous secondary battery of the embodiment in which modified physical-property portions are formed on both surfaces of the separator.

FIG. 5 is a cross-sectional view illustrating a separator for the nonaqueous secondary battery of the embodiment in which a modified physical-property portion is formed in one surface of the separator.

FIG. 6 is a cross-sectional view illustrating a separator for the nonaqueous secondary battery of the embodiment in which a modified physical-property portion is formed in one surface of the separator.

FIGS. 7(a) and 7(b) are surface SEM photographs showing a separator for the nonaqueous secondary battery of the embodiment. FIG. 7(a) is an SEM photograph showing a surface not subjected to physical-property modification, and FIG. 7(b) is an SEM photograph showing a surface subjected to physical-property modification.

FIG. 8 is a partially cut-away perspective view illustrating the nonaqueous secondary battery of the embodiment.

FIG. 9 is a perspective view illustrating a conventional electrode plate.

FIG. 10 is a cross-sectional view illustrating a conventional electrode plate.

### DESCRIPTION OF EMBODIMENTS

An embodiment of the present invention will be described hereinafter with reference to the drawings. It should be noted that the present invention is not limited to the following embodiment. Various changes and modifications may be made without departing from the scope of the present invention, and the following embodiment may be combined with other embodiments.

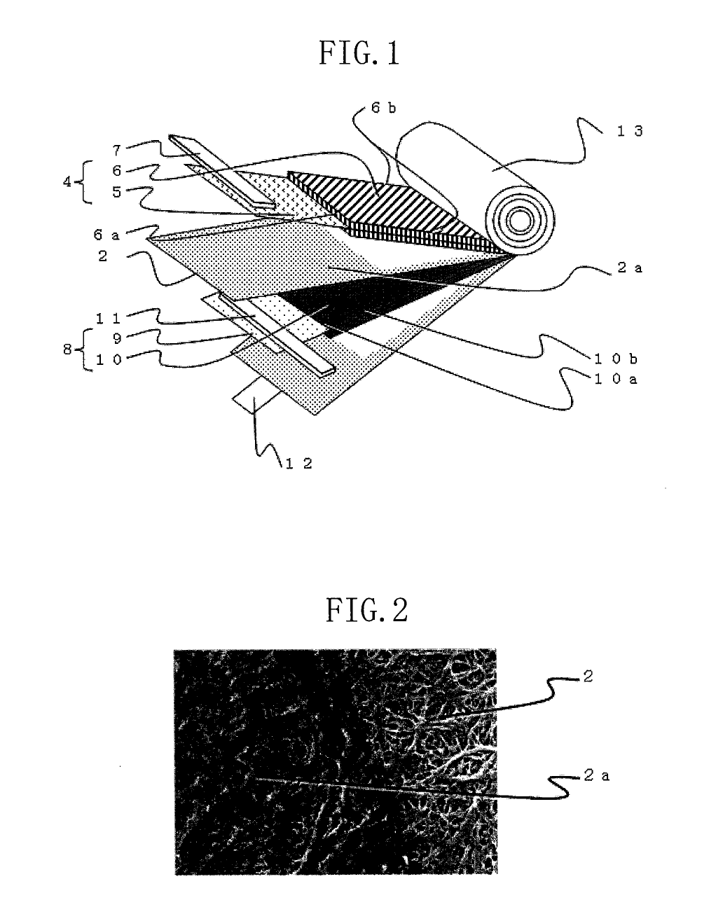

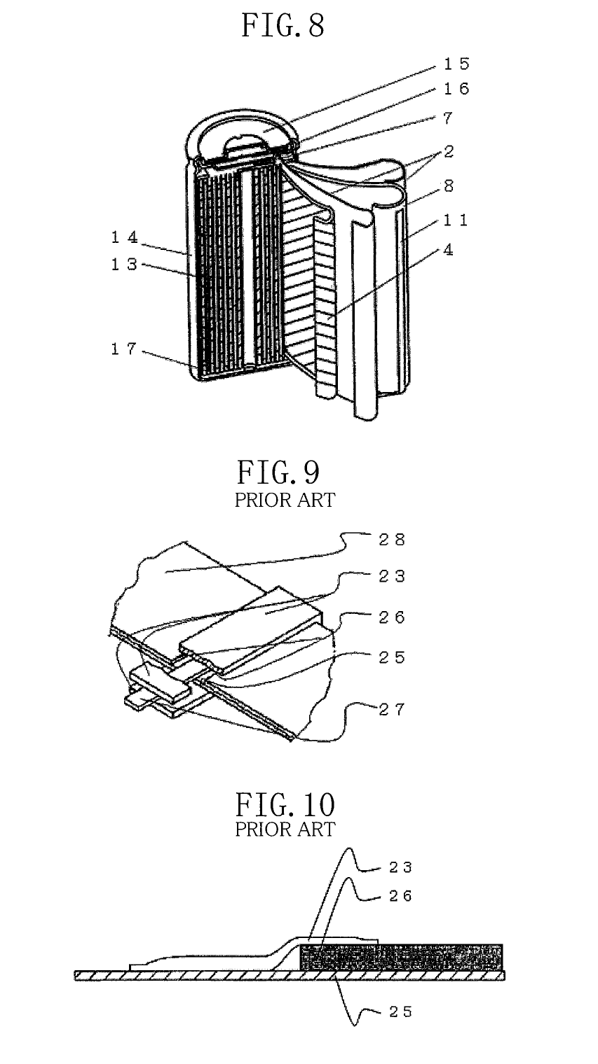

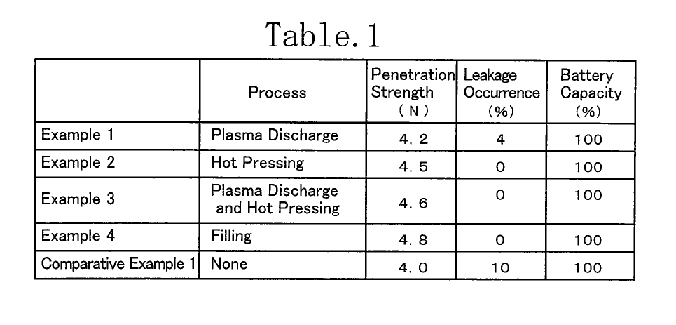

As illustrated in FIG. 1, a battery of the present invention is fabricated in the following manner. A positive electrode plate 4 formed by connecting a positive electrode lead (a current collector lead) 7 to a portion of a positive electrode current collector 5 on which a positive electrode active material layer 6 is not formed, and a negative electrode plate 8 formed by connecting a negative electrode lead (a current collector lead) 11 to a portion of a negative electrode current collector 9 on which a negative electrode active material layer 10 is not formed, are wound with a separator 2 interposed therebetween, and are fixed together with a winding fixture tape 12, thereby forming an electrode group 13. The separator 2 has a modified physical-property portion 2a formed by reducing the porosity in a specific portion, as shown in FIG. 2. The electrode group 13 is housed in a battery case 14 together with an electrolyte as shown in FIG. 8. In this manner, a battery is fabricated.

Then, the configuration of the battery is more specifically described. As illustrated in FIG. 1, for example, the positive electrode plate 4 using composite lithium oxide as a positive electrode active material and the negative electrode plate 8 using a material capable of holding lithium as a negative electrode active material are wound in a spiral with the separator 2 interposed therebetween, thereby forming the electrode group 13. As illustrated in FIG. 8, the electrode group 13 is housed in the closed-end cylindrical battery case 14 together with an insulating plate 17. The negative electrode lead 11 extending from a lower portion of the electrode group 13 is connected to the bottom of the battery case 14. Then, the positive electrode lead 7 extending from an upper portion of the electrode group 13 is connected to a sealing plate 15. Thereafter, an electrolyte (not shown) made of a predetermined amount of a nonaqueous solvent is poured into the battery case 14. Subsequently, a sealing gasket 16 is attached to the edge of the sealing plate 15, and the sealing plate 15 in this state is inserted through an opening of the battery case 14. Then, the edge of the opening of the battery case 14 is bent inward, and is sealed by crimping.

Next, the structures of the modified physical-property portion 2a of the separator 2, the positive electrode plate 4, and the negative electrode plate 8 are specifically described. The separator 2 is not specifically limited as long as the separator 2 has a composition with which the separator 2 can stand in the operating range of the nonaqueous electrolyte secondary battery. For the separator 2, one or a combination of microporous films made of olefin-based resin such as polyethylene and polypropylene are generally and preferably used. The thickness of the separator 2 is not specifically limited, and may be in the range from 10 μm to 25 μm.

The modified physical-property portion 2a of the separator 2 is formed by modifying portions of the separator 2 respectively associated with a coating start/terminal end 6a of the positive electrode active material layer 6, a coating start/terminal end 10a of the negative electrode active material layer 10, a cutting end 6b of the positive electrode active material layer 6, a cutting end 10b of the negative electrode active material layer 10, ends of the positive electrode lead 7 and the negative electrode lead 11, ends of the positive electrode current collector 5 and the negative electrode current collector 9, as illustrated in FIG. 1, such that the porosity is reduced and the hardness and the crushing strength are increased.

In the non-modified physical-property portion of the separator 2 except for the modified physical-property portion 2a where the positive electrode plate 4 and the negative electrode plate 8 face each other in a large area to cause battery reaction, no such physical-property modification as an increase in the crushing strength obtained by reducing the porosity is performed. Thus, the non-modified physical-property portion does not affect ion movement during charge and discharge of the battery.

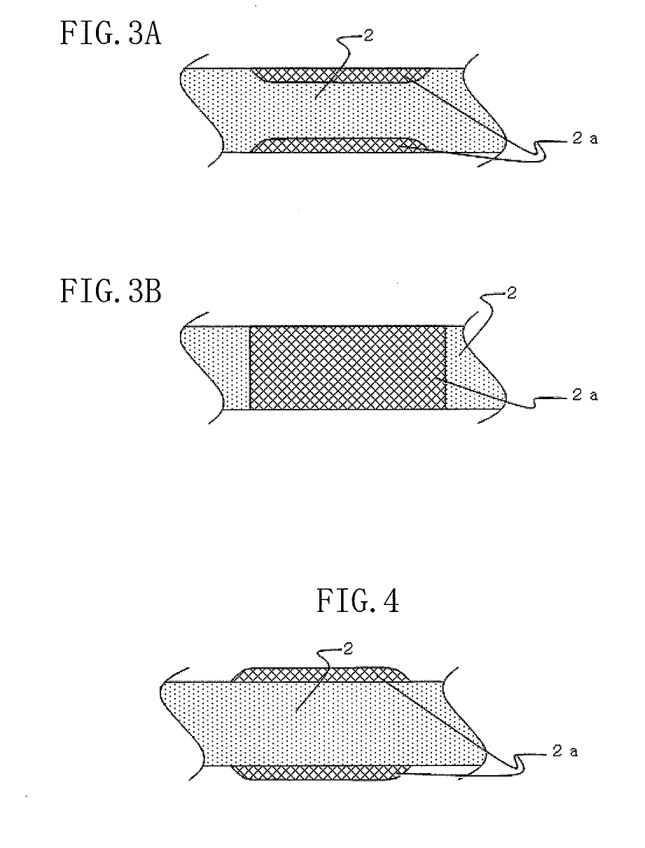

As an example of local modification of physical properties, the crushing strength is increased in the following manner. As illustrated in FIG. 2, for example, the resin surface of the separator 2 is welded and pressed by hot pressing. Accordingly, as illustrated in the cross section of FIG. 3(a), pores in the surface of the porous separator 2 are filled, and thus, extension of cracks starting from pores in the surface is reduced during a crushing test or piercing of foreign substances, thereby increasing the crushing strength. In addition, as illustrated in FIG. 3(b), modification of physical properties may be performed in the entire separator 2 in cross section.

Further, the separator 2 itself does not need to be welded, and the separator 2 may be filled and combined with resin having an affinity for the separator 2 so that the modified physical-property portion 2a as illustrated in FIGS. 3(a) and 3(b) is provided so as to increase the crushing strength.

The separator 2 itself does not need to be welded or filled, and resin having an affinity for the separator 2 may be bonded to, or combined with, the separator 2 so that the modified physical-property portion 2a as illustrated in FIG. 4 is provided so as to increase the crushing strength. Here, “bonding” means that materials are bonded together with a binder, and “combining” means that materials are mechanically/chemically merged.

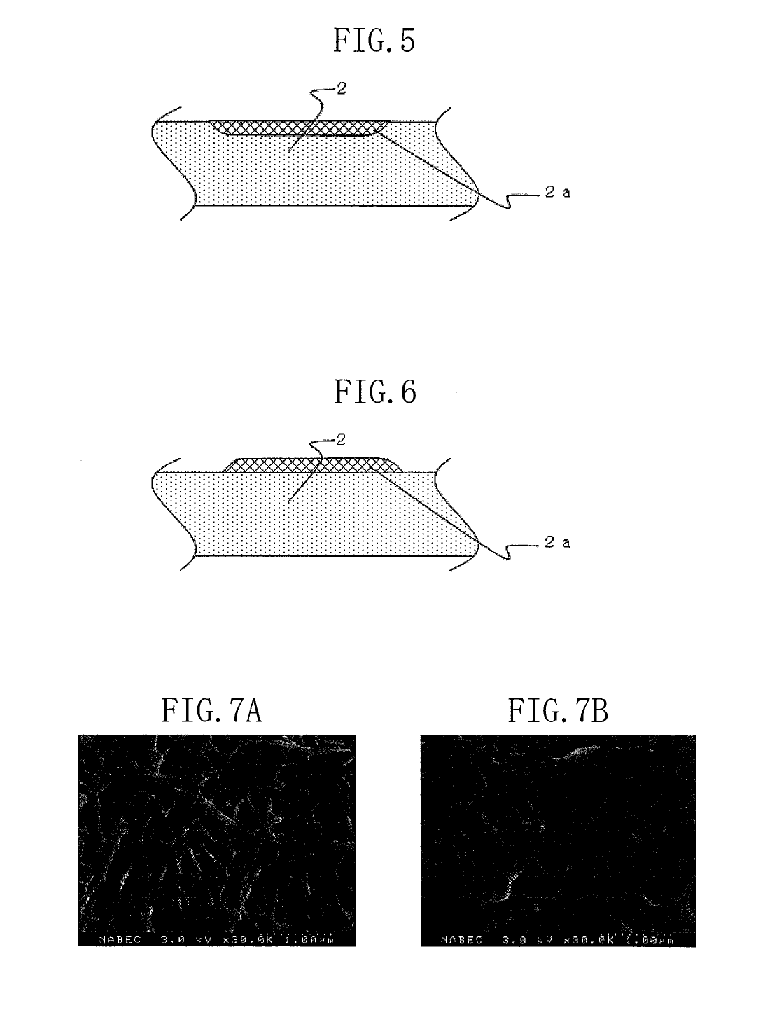

Moreover, as illustrated in FIGS. 5 and 6, the modified physical-property portion 2a may be formed in one surface of the separator 2. In this case, the crushing strength of a desired portion of a desired surface can be increased.

The surface of the separator 2 may be filled with adhesive resin so that the modified physical-property portion 2a of the separator 2 is formed. In this modified physical-property portion 2a, the number of pores is small (or zero), resulting in that the voltage endurance and the crushing strength are increased. In addition, since the modified physical-property portion 2a has an adhesive property, the modified physical-property portion 2a can be disposed with stability on a portion associated with a sharp portion such as an end of the electrode plate. As a result, an internal short circuit caused by penetration through the separator can be more effectively reduced. FIG. 7(a) shows a surface SEM photograph of a portion not subjected to modification of physical properties. FIG. 7(b) shows a surface SEM photograph of a portion of the separator subjected to modification of physical properties. As shown in FIG. 7(b), the modified physical-property portion 2a has a small number of pores.

The positive electrode plate 4 is not specifically limited, and metal foil having a thickness of 5 μm to 30 μm and made of aluminium, an aluminium alloy, nickel, or a nickel alloy may be used as the positive electrode current collector 5. A positive electrode material mixture paste to be applied on the positive electrode current collector 5 is formed by mixing and dispersing a positive electrode active material, a conductive agent, and a binder in a dispersion medium with a disperser such as a planetary mixer.

Specifically, the positive electrode active material, the conductive agent, and the binder are placed in an appropriate dispersion medium, are mixed and dispersed with a disperser such as a planetary mixer, and then are kneaded so that the viscosity is adjusted to an optimum value for application on the current collector, thereby forming a positive electrode material mixture paste.

Examples of the positive electrode active material include complex oxides such as lithium cobaltate, denatured lithium cobaltate (e.g., a substance in which aluminium or magnesium is dissolved in lithium cobaltate), lithium nickelate, denatured lithium nickelate (e.g., a substance in which nickel partially substitutes for cobalt), lithium manganate, and denatured lithium manganate.

As the conductive agent, carbon black such as acetylene black, Ketjen black, channel black, furnace black, lamp black, and thermal black, and various types of graphite may be used solely or a two or more of these materials may be used in combination, for example.

Examples of the binder for the positive electrode include polyvinylidene fluoride (PVdF), denatured polyvinylidene fluoride, polytetrafluoroethylene (PTFE), and rubber particle binder containing acrylate units. Acrylate monomer to which a reactive functional group is introduced or acrylate oligomer may be mixed in the binder.

Then, the positive electrode material mixture paste formed as described above by using a die coater is applied on the positive electrode current collector 5 made of aluminium foil, is dried, and then is pressed to a predetermined thickness, thereby obtaining the positive electrode plate 4 formed out of the positive electrode active material layer 6.

The negative electrode plate 8 is not specifically limited, and metal foil having a thickness of 5 μm to 25 μm and made of copper or a copper alloy may be used as the negative electrode current collector 9. A negative electrode material mixture paste to be applied on the negative electrode current collector 9 is formed by mixing and dispersing a negative electrode active material, a binder, and, when necessary, a conductive agent and a thickener, in a dispersion medium with a disperser such as a planetary mixer.

Specifically, the negative electrode active material and the binder are placed in an appropriate dispersion medium, are mixed and dispersed with a disperser with a planetary mixer, and then are kneaded so that the viscosity is adjusted to an optimum value for application on the current collector, thereby forming a negative electrode material mixture paste.

Examples of the negative electrode active material include various types of natural graphite, artificial graphite, silicon-based composite materials such as silicide, and various types of alloy composition materials.

Examples of the negative electrode binder include PVdF and denatured PVdF. To enhance lithium ion acceptability, styrene-butadiene rubber (SBR) particles, denatured SBR, and cellulose-based resin such as carboxymethyl cellulose (CMC) are also preferably used or a material obtained by adding a small amount of such materials to the SBR particles or the denatured SBR particles is preferably used.

Then, the negative electrode material mixture paste formed as described above by using a die coater is applied on the negative electrode current collector 9 made of copper foil, is dried, and then is pressed to a predetermined thickness, thereby obtaining the negative electrode plate 8 formed out of the negative electrode active material layer 10.

For the nonaqueous electrolyte, various types of lithium compounds such as LiPF₆ and LiBF₄ may be used as electrolyte salt. As a solvent, ethylene carbonate (EC), dimethyl carbonate (DMC), diethyl carbonate (DEC), or methyl ethyl carbonate (MEC) may be used solely or two or more of them may be used in combination. To ensure formation of high-quality coatings on the positive and negative electrode plates and safety at overdischarge, vinylene carbonate (VC), cyclohexylbenzene (CHB), and denatured CHB are preferably used.

As illustrated in FIG. 8, the electrode group 13 formed by winding the positive electrode plate 4 and the negative electrode plate 8 with the separator 2 interposed therebetween as shown in FIG. 1, is housed in the closed-end cylindrical battery case 14, together with the insulating plate 17. Then, the negative electrode lead 11 extending from the lower portion of the electrode group 13 is connected to the bottom of the battery case 14. Subsequently, the positive electrode lead 7 extending from the upper portion of the electrode group 13 is connected to the sealing plate 15. Thereafter, an electrolyte (not shown) made of a predetermined amount of a nonaqueous solvent is poured in the battery case 14. Subsequently, the sealing gasket 16 is attached to the edge of the sealing plate 15, and the sealing plate 15 in this state is inserted through the opening of the battery case 14. Then, the edge of the opening of the battery case 14 is bent inward, and is sealed by crimping. In this manner, a nonaqueous secondary battery is fabricated.

### EXAMPLES

Specific examples will be described in detail hereinafter.

### Example 1

A separator 2 of EXAMPLE 1 having a thickness of 20 μm was obtained in the following manner. Portions of the separator 2 having a width of about 5 mm and respectively associated with a coating start/terminal end 6a of a positive electrode active material layer 6, a coating start/terminal end 10a of a negative electrode active material layer 10, a cutting end 10b of the positive electrode active material layer 6, a cutting end 10b of the negative electrode active material layer 10, ends of positive and negative electrode leads 7 and 11, and ends of positive and negative electrode current collectors 5 and 9, were irradiated with plasma for 0.5 seconds at a low voltage with a plasma exposure apparatus from a distance of 10 mm, thereby forming a modified physical-property portion 2a in the separator 2.

Further, an electrode group 13 formed by winding a positive electrode plate 4 and a negative electrode plate 8 with the separator 2 of EXAMPLE 1 interposed therebetween as illustrated in FIG. 1, was housed in a closed-end cylindrical battery case 14, together with an insulating plate 17, as illustrated in FIG. 8. The negative electrode lead 11 extending from a lower portion of the electrode group 13 was connected to the bottom of the battery case 14. Then, the positive electrode lead 7 extending from an upper portion of the electrode group 13 was connected to a sealing plate 15. Thereafter, an electrolyte (not shown) made of a predetermined amount of a nonaqueous solvent was poured in the battery case 14. Subsequently, a sealing gasket 16 was attached to the edge of the sealing plate 15, and the sealing plate 15 in this state was inserted through an opening of the battery case 14. Then, the edge of the opening of the battery case 14 was bent inward, and was sealed by crimping. In this manner, a nonaqueous secondary battery of EXAMPLE 1 was fabricated.

### Example 2

A separator 2 of EXAMPLE 2 having a thickness of 20 μm was obtained in the following manner. Portions of the separator 2 having a width of about 5 mm and respectively associated with a coating start/terminal end 6a of a positive electrode active material layer 6, a coating start/terminal end 10a of a negative electrode active material layer 10, a cutting end 6b of the positive electrode active material layer 6, a cutting end 10b of the negative electrode active material layer 10, ends of positive and negative electrode leads 7 and 11, and ends of positive and negative electrode current collectors 5 and 9, were sandwiched between a metal heater and a metal plate under a pressure of 1 N, and were pressed by hot pressing for 10 minutes at a heater temperature of 150° C., thereby forming a modified physical-property portion 2a in the separator 2.

Further, an electrode group 13 formed by winding a positive electrode plate 4 and a negative electrode plate 8 with the separator 2 of EXAMPLE 2 interposed therebetween as illustrated in FIG. 1, was housed in a closed-end cylindrical battery case 14, together with an insulating plate 16, as illustrated in FIG. 8. The negative electrode lead 11 extending from a lower portion of the electrode group 13 was connected to the bottom of the battery case 14. Then, the positive electrode lead 7 extending from an upper portion of the electrode group 13 was connected to a sealing plate 15. Thereafter, an electrolyte (not shown) made of a predetermined amount of a nonaqueous solvent was poured in the battery case 14. Subsequently, a sealing gasket 16 was attached to the edge of the sealing plate 15, and the sealing plate 15 in this state was inserted through an opening of the battery case 14. Then, the edge of the opening of the battery case 14 was bent inward, and was sealed by crimping. In this manner, a nonaqueous secondary battery of EXAMPLE 2 was fabricated.

### Example 3

A separator 2 of EXAMPLE 3 having a thickness of 20 μm was obtained in the following manner. Portions of the separator 2 having a width of about 5 mm and respectively associated with a coating start/terminal end 6a of a positive electrode active material layer 6, a coating start/terminal end 10a of a negative electrode active material layer 10, a cutting end 6b of the positive electrode active material layer 6, a cutting end 10b of the negative electrode active material layer 10, ends of positive and negative electrode leads 7 and 11, and ends of positive and negative electrode current collectors 5 and 9, were irradiated with plasma for 0.5 seconds at a low voltage with a plasma exposure apparatus from a distance of 10 mm, were sandwiched between a metal heater and a metal plate under a pressure of 1 N, and then were pressed by hot pressing for 10 minutes at a heater temperature of 150° C., thereby forming a modified physical-property portion 2a in the separator 2.

Further, an electrode group 13 formed by winding a positive electrode plate 4 and a negative electrode plate 8 with the separator 2 of EXAMPLE 3 interposed therebetween as illustrated in FIG. 1, was housed in a closed-end cylindrical battery case 14, together with an insulating plate 16, as illustrated in FIG. 8. The negative electrode lead 11 extending from a lower portion of the electrode group 13 was connected to the bottom of the battery case 14. Then, the positive electrode lead 7 extending from an upper portion of the electrode group 13 was connected to a sealing plate 15. Thereafter, an electrolyte (not shown) made of a predetermined amount of a nonaqueous solvent was poured in the battery case 14. Subsequently, a sealing gasket 16 was attached to the edge of the sealing plate 15, and the sealing plate 15 in this state was inserted through an opening of the battery case 14. Then, the edge of the opening of the battery case 14 was bent inward, and was sealed by crimping. In this manner, a nonaqueous secondary battery of EXAMPLE 3 was fabricated.

### Example 4

A separator 2 of EXAMPLE 4 having a thickness of 20 μm was obtained in the following manner. Portions of the separator 2 having a width of about 5 mm and respectively associated with a coating start/terminal end 6a of a positive electrode active material layer 6, a coating start/terminal end 10a of a negative electrode active material layer 10, a cutting end 6b of the positive electrode active material layer 6, a cutting end 10b of the negative electrode active material layer 10, ends of positive and negative electrode leads 7 and 11, and ends of positive and negative electrode current collectors 5 and 9, were coated with a resin of the same type as a melted portion of the separator, and were cooled with the thickness of the separator 2 restricted while being sandwiched between metal plates, thereby forming a modified physical-property portion 2a in the separator 2.

Further, an electrode group 13 formed by winding a positive electrode plate 4 and a negative electrode plate 8 with the separator 2 of EXAMPLE 4 interposed therebetween as illustrated in FIG. 1, was housed in a closed-end cylindrical battery case 14, together with an insulating plate 17, as illustrated in FIG. 8. The negative electrode lead 11 extending from a lower portion of the electrode group 13 was connected to the bottom of the battery case 14. Then, the positive electrode lead 7 extending from an upper portion of the electrode group 13 was connected to a sealing plate 15. Thereafter, an electrolyte (not shown) made of a predetermined amount of a nonaqueous solvent was poured in the battery case 14. Subsequently, a sealing gasket 16 was attached to the edge of the sealing plate 15, and the sealing plate 15 in this state was inserted through an opening of the battery case 14. Then, the edge of the opening of the battery case 14 was bent inward, and was sealed by crimping. In this manner, a nonaqueous secondary battery of EXAMPLE 4 was fabricated.

### Comparative Example 1

As a separator 2 of COMPARATIVE EXAMPLE 1, a separator 2 having a thickness of 20 μm and including no modified physical-property portion was formed.

Further, an electrode group 13 formed by winding a positive electrode plate 4 and a negative electrode plate 8 with the separator 2 of COMPARATIVE EXAMPLE 1 interposed therebetween as illustrated in FIG. 1, was housed in a closed-end cylindrical battery case 14, together with an insulating plate 17, as illustrated in FIG. 8. A negative electrode lead 11 extending from a lower portion of the electrode group 13 was connected to the bottom of the battery case 14. Then, a positive electrode lead 7 extending from an upper portion of the electrode group 13 was connected to a sealing plate 15. Thereafter, an electrolyte (not shown) made of a predetermined amount of a nonaqueous solvent was poured in the battery case 14. Subsequently, a sealing gasket 16 is attached to the edge of the sealing plate 15, and the sealing plate 15 in this state was inserted through an opening of the battery case 14. Then, the edge of the opening of the battery case 14 was bent inward, and was sealed by crimping. In this manner, a nonaqueous secondary battery of COMPARATIVE EXAMPLE 1 was fabricated.

Table 1 shows a result of comparison obtained by performing a crushing strength test on a modified physical-property portion 2a formed in the manner described above.

In the crushing strength test, the separator 2 was fixed by a washer with a diameter of 12 mm, and the fixed separator 2 was pierced with a pin at a speed of 100 mm/min. The maximum load (N) in this case was obtained as the crushing strength. As the shape of the pin, the diameter of the pin was 1 mm, and was 0.5 R at the tip thereof.

Leakage occurrence was evaluated in the following manner. First, 100 electrode groups 13 each formed by winding a positive electrode plate 4 and a negative electrode plate 8 with the separator 2 of one of the above examples and COMPARATIVE EXAMPLE interposed therebetween, were prepared as a unit. Then, a voltage of 800 V was applied to each unit of the electrode groups 13 through the positive electrode leads 7 and the negative electrode leads 11. Electrode groups 13 in which 0.1 mA or more of current flows were defined as leakage-observed products. The leakage occurrence (%) was calculated by dividing the number of leakage-observed products by 100 as the population parameter. The battery capacity was evaluated by comparing the discharge capacities of the nonaqueous secondary batteries fabricated using the separators 2 of EXAMPLES 1-3 and COMPARATIVE EXAMPLE 1, with the discharge capacity of COMPARATIVE EXAMPLE 1 defined as 100.

TABLE 1

| | | Penetration | Leakage | Battery |
|---|---|---|---|---|
| | | Strength | Occurrence | Capacity |
| | Process | (N) | (%) | (%) |
| Example 1 | Plasma Discharge | 4.2 | 4 | 100 |
| Example 2 | Hot Pressing | 4.5 | 0 | 100 |
| Example 3 | Plasma Discharge | 4.6 | 0 | 100 |
| | and Hot Pressing | | | |
| Example 4 | Filling | 4.8 | 0 | 100 |
| Comparative | None | 4.0 | 10 | 100 |
| Example 1 | | | | |

As shown in Table 1, as compared to the separator 2 of COMPARATIVE EXAMPLE 1, the separator 2 of EXAMPLE 1 is considered to have the two following advantages. First, since a functional group (e.g., an oxygen double bond or a hydroxyl group) having a polar moment greater than that of polyolefin-based polymer was added to the surface of the separator 2 through plasma discharge, the crushing strength of the separator 2 increased. Second, heat generated during plasma discharge caused the surfaces of pores in the separator 2 to be welded to reduce the porosity and, thus, reduce breakage of the separator 2, resulting in an increase in the crushing strength.

Further, in the separator 2 of EXAMPLE 2, pores in the separator 2 were crushed by hot pressing as shown in FIG. 2. Accordingly, breakage of the separator 2 subjected to modification of physical properties was reduced during crushing, and was also reduced in the electrode group 13. Thus, reduction of an internal short circuit can be expected.

In the separator 2 of EXAMPLE 3 subjected to hot pressing in addition to plasma discharge, the hot pressing performed on the separator 2 of EXAMPLE 2 greatly affected the physical property values, and the plasma discharge slightly increased the crushing strength. Thus, the porosity was almost equal to that in the case of EXAMPLE 2.

In the separator 2 of EXAMPLE 4 subjected to filling, as compared to EXAMPLES 1-3, since pores were filled with resin, the volume of the separator 2 itself increased, thereby increasing the hardness and the crushing strength.

With respect the leakage occurrences in the electrode groups 13 using the separators 2 of the above examples, the leakage occurrence was reduced in EXAMPLE 1, and no leakage occurred in EXAMPLES 2 and 3, as compared to COMPARATIVE EXAMPLE 1 exhibiting a low crushing strength.

With respect to the capacities of the nonaqueous secondary batteries using the separators 2 of the above examples, the battery capacities did not decrease in EXAMPLES 1-4, unlike COMPARATIVE EXAMPLE 1.

Although the above examples are directed to lithium ion secondary batteries, the same advantages can also be obtained for alkaline storage batteries and lithium batteries of other types where ions are exchanged between the positive electrode plate 4 and the negative electrode plate 8 through the separator 2.

### INDUSTRIAL APPLICABILITY

A nonaqueous secondary battery according to the present invention is useful as a power supply, such as a lithium ion secondary battery, an alkaline storage battery, or a lithium battery, for mobile electronic equipment.

### DESCRIPTION OF REFERENCE CHARACTERS

2 separator
2a modified physical-property portion
4 positive electrode plate
5 positive electrode current collector
6 positive electrode active material layer
6a coating start/terminal end
6b cutting end
7 positive electrode lead
8 negative electrode plate
9 negative electrode current collector
10 negative electrode active material layer
10a coating start/terminal end
10b cutting end
11 negative electrode lead
12 winding fixture tape
13 electrode group
14 battery case
15 sealing plate
16 sealing gasket
17 insulating plate

1. A battery in which each of a positive electrode plate and a negative electrode plate is formed by coating a surface of a strip-shaped current collector with an active material layer, and in which an electrode group formed by winding or stacking the positive electrode plate and the negative electrode plate with a separator interposed therebetween and an electrolyte are housed in a battery case, wherein
at least a predetermined portion of the separator associated with either a coating start/terminal end of the active material layer or an end of the current collector is formed as a modified physical-property portion having a strength against a crush.

2. The battery of claim 1, wherein the modified physical-property portion of the separator is formed by performing hot pressing or discharging on the predetermined portion of the separator.

3. The battery of claim 1, wherein the modified physical-property portion of the separator is formed by filling the predetermined portion of the separator with a resin material, bonding the resin material to the predetermined portion of the separator, or combining the resin material with the predetermined portion of the separator.

4. The battery of claim 1, wherein the modified physical-property portion of the separator is located inside the separator.

5. The battery of claim 1, wherein the modified physical-property portion of the separator is located in a surface of the separator.

6. The battery of claim 1, wherein the strip-shaped current collector is formed by cutting a sheet-shaped current collector having a surface on which the active material layer is formed, and
a portion of the separator associated with a cutting end of the active material layer is also formed as the modified physical-property portion of the separator.

7. The battery of claim 1, wherein a current collector lead is connected to a portion of the current collector where the active material layer is not formed, and
a portion of the separator associated with an end of the current collector lead is also formed as the modified physical-property portion of the separator.
